(19) United States
(12) Patent Application Publication
(10) Pub. No.: US 2005/0193200 A1
(43) Pub. Date: Sep. 1, 2005

(54) Image processing apparatus and method, storage medium storing computer-readable program, and program

(75) Inventors: Rieko Akiba, Setagaya-ku (JP); Etsuko Maeda, Ohta-ku (JP); Tatsuo Shinagawa, Yokohama-shi (JP); Shuji Someya, Adachi-ku (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/064,809

(22) Filed: Feb. 24, 2005

(30) Foreign Application Priority Data
Feb. 27, 2004 (JP) 2004-053192

(51) Int. Cl. H04L 9/00

(52) U.S. Cl. 713/168

(57) ABSTRACT

An image processing apparatus extracts feature information from electronic data to be transmitted to an output device, and encrypts the electronic data before transmitting it to the output device. The image processing apparatus manages an output time and date at which the transmitted electronic data is to be printed, and transmits a decryption key for decrypting the transmitted encrypted electronic data to the output device at the output time and date. A hash value extracted from the electronic data decrypted by the output device is checked against a hash value extracted by the image processing apparatus. When these hash values are consistent with each other, the image processing apparatus instructs printing of the electronic data decrypted by the output device.

### BACKGROUND OF THE INVENTION

1. Field of the Invention

The present invention relates to an image processing apparatus and method for sending encrypted electronic data to an image processing apparatus that outputs the electronic data, and further relates to a storage medium storing a computer-readable program, and to the program.

2. Description of the Related Art

Systems for allowing a device to print various types of data from another device serving as a printer have been commercially available.

In a first system, an information processing apparatus, such as a personal computer (PC) or an image processing apparatus, generates various types of data, and instructs another image processing apparatus to print the data. In a second system, an information processing apparatus, such as a PC or an image processing apparatus, generates various types of data, and the generated data is stored in a storage unit, such as a hard disk (HD), of another image processing apparatus before the user of this image processing apparatus operates on a screen of the image processing apparatus to print the data stored in the storage unit.

The first and second systems are systems that allow a device to print data from another device. A third system is an authenticated printing system, which is disclosed in Japanese Patent Laid-Open No. 2003-084962.

In the third system, a printer includes an authenticity verifying unit, and prints only authenticated data, thus assuring authentic printing.

In these systems, however, printing is not always guaranteed. If high-security data is to be securely printed at a specified time, e.g., when an admission ticket, a boarding ticket, or an examination answer sheet is converted into electronic data and the electronic data is printed from a printer of the examination grader for grading, the first system in which the data is transmitted immediately before printed cannot guarantee printing, due to network traffic, etc.

In the second system, although the data is transmitted in advance, data loss or data tampering can occur after transmission, and printing at a specified time and date cannot be guaranteed.

In the third system, a printer itself assures authentic printing. However, when the data is sent from a server, for example, if an authenticity verification program in a printer that sent the data is modified, the final printout cannot be authenticated. The third system does not assure security for data viewing after transmission.

### SUMMARY OF THE INVENTION

The present invention provides a system for assuring that image data is output from an output device at a specified time and for assuring the authenticity of image data to be printed.

In one aspect of the present invention, an image processing apparatus for transmitting encrypted electronic data to an output device includes an extracting unit that extracts first feature information from electronic data that is not encrypted, an encryption unit that encrypts the electronic data, a transmitting unit that transmits the encrypted electronic data and a decryption key for decrypting the encrypted electronic data to the output device, a managing unit that manages the first feature information extracted by the extracting unit and output time and date at which the encrypted electronic data transmitted by the transmitting unit and stored in the output device is to be output by the output device, so that the transmitting unit transmits the decryption key at the output time and date, an obtaining unit that obtains second feature information of electronic data that is decrypted by the output device using the decryption key transmitted by the transmitting unit, the second feature information being generated by the output device, a verifying unit that verifies whether or not the second feature information obtained by the obtaining unit is consistent with the first feature information, and an instructing unit that instructs the output device to output the decrypted electronic data when the verifying unit verifies that the first feature information is consistent with the second feature information.

In another aspect of the present invention, an image output device for receiving encrypted electronic data from an image processing apparatus and operating a printing process based on the electronic data includes a storage unit that stores the encrypted electronic data received from the image processing apparatus, an obtaining unit that obtains from the image processing apparatus a decryption key for decrypting the encrypted electronic data stored in the storage unit, a feature information extracting unit that extracts feature information from electronic data decrypted using the decryption key obtained by the obtaining unit, and that transmits the extracted feature information to the image processing apparatus, and a control unit that controls the printing process of the electronic data according to an output instruction that is received from the image processing apparatus in response to the feature information transmitted to the image processing apparatus by the feature information extracting unit.

Further features and advantages of the present invention will become apparent from the following description of exemplary embodiments with reference to the attached drawings.

### BRIEF DESCRIPTION OF THE DRAWINGS

FIG. 1 is a diagram of an image processing system including an image processing apparatus according to an embodiment of the present invention.

FIG. 2 is an illustration of decryption processing performed by the image processing apparatus shown in FIG. 1.

FIG. 3 is an illustration of data processing performed by a feature value determining unit shown in FIG. 2.

FIG. 4 is a flowchart showing a first data processing procedure performed by the image processing apparatus according to the present invention.

FIG. 5 is a flowchart showing a second data processing procedure performed by the image processing apparatus according to the present invention.

FIG. 6 is a flowchart showing a third data processing procedure performed by the image processing apparatus according to the present invention.

FIG. 7 is a memory map of a storage medium that stores various data processing programs readable by the image processing system according to the present invention.

### DESCRIPTION OF THE EMBODIMENTS

Embodiments of the present invention will now be described with reference to the drawings.

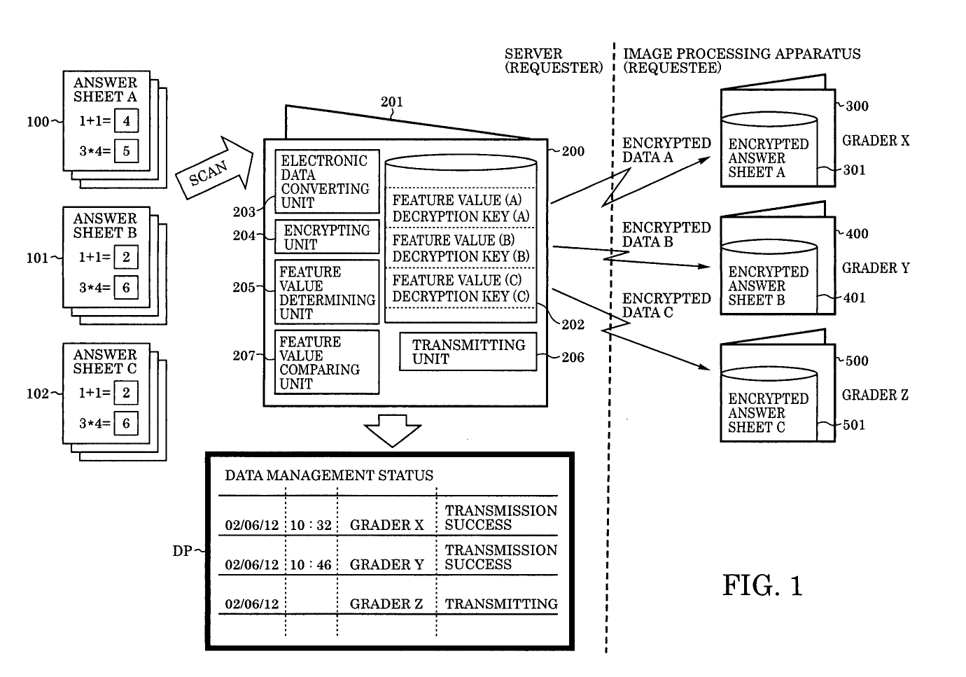

FIG. 1 is a diagram of an image processing system including an image processing apparatus according to an embodiment of the present invention. In this system, a server, which is a job requester, sends electronic data of answer sheets A, B, and C (100, 101, and 102) to grading companies X, Y, and Z, which are job requestees, respectively, so that the answer sheets A, B, and C are printed from image processing apparatuses 300, 400 and 500 of the grading companies X, Y, and Z at a time when grading begins, to grade the answer sheets A, B, and C.

In FIG. 1, an image processing server 200 includes a reader 201 that reads an original document, an electronic data converting unit 203 that converts the read original document into electronic data, such as TIFF or JPEG data, an encrypting unit 204 that encrypts the electronic data, a feature value determining unit 205 that determines a feature value of the electronic data, a storage unit 202 that manages and stores the determined feature value, the electronic data, a decryption key for decrypting the encrypted document, etc., a transmitting unit 206 that transmits the electronic data to another device connected via a network, and a feature value comparing unit 207 described below.

The image processing server 200 further includes an input unit (not shown) that is operated to transmit the electronic data to another device.

The image processing apparatuses 300, 400 and 500 (such as printers) that are connected to the image processing server 200 via a network or the like include HDs 301, 401, and 501, respectively, for storing the encrypted electronic data transmitted from the image processing server 200.

The image processing server 200 further includes a display unit DP that displays a management status of transmitted data. In FIG. 1, the display unit DP shows a transmission state.

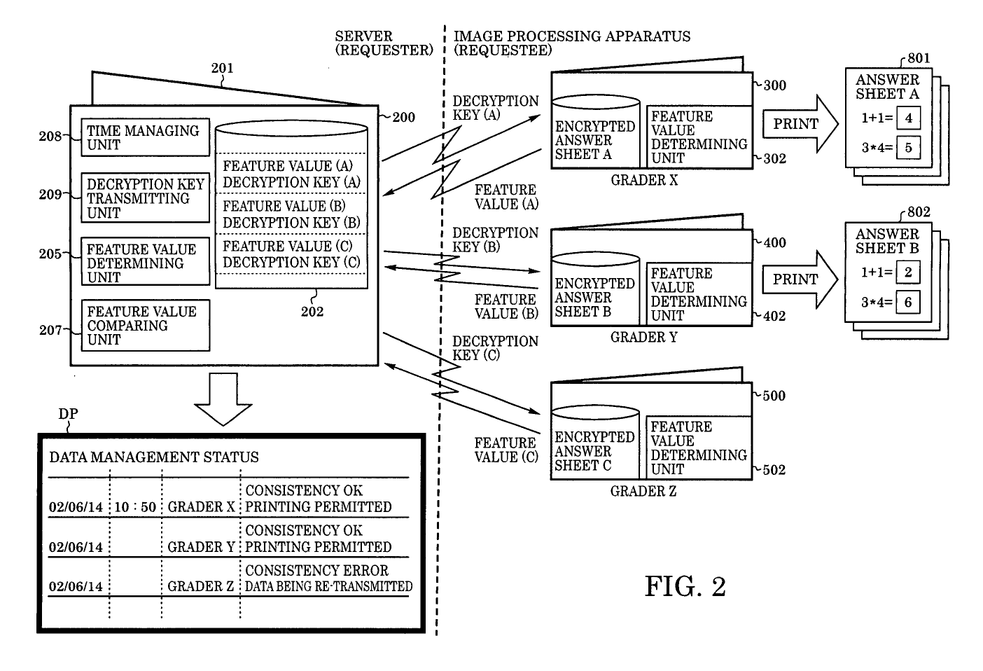

FIG. 2 illustrates decryption processing performed by the image processing apparatuses 300, 400 and 500 shown in FIG. 1, and the same portions as those shown in FIG. 1 are given the same reference numerals. In this image processing system, the encrypted data stored in the image processing apparatuses 300, 400 and 500, i.e., the answer sheets A, B, and C, are printed.

In FIG. 2, the image processing server 200 further includes a time managing unit 208 for controlling the print start time, and a decryption key transmitting unit 209 that transmits decryption keys to the image processing apparatuses 300, 400 and 500 at a predetermined print start time.

When the image processing apparatuses 300, 400 and 500 receive the corresponding decryption keys, decryption units (not shown) of the image processing apparatuses 300, 400 and 500 decrypt the stored encrypted electronic data. The image processing apparatuses 300, 400 and 500 further include feature value determining units 302, 402, and 502, respectively, for determining feature values of the decrypted electronic data, and the determined feature values are transmitted to the image processing server 200.

The feature value comparing unit 207 of the image processing server 200 compares the feature values received from the image processing apparatuses 300, 400 and 500 with the feature values stored in advance in the storage unit 202 to determine whether or not the data has been tampered with. The image processing server 200 sends a printing instruction to the image processing apparatuses 300 and 400 that are verified. In response to the printing instruction, the image processing apparatuses 300 and 400 output answer sheets 801 and 802, respectively.

The display unit DP of the image processing server 200 displays a data management status. In the data management status, a message indicating consistency between the managed data and the transmitted data, and the printing state are shown.

In the present embodiment, if the feature value comparing unit 207 finds a consistency error, e.g., if the feature value comparing unit 207 compares the feature value received from the image processing apparatus 500 with the feature value stored in advance in the storage unit 202 and determines that the data is tampered with, the image processing server 200 re-transmits electronic data that is not encrypted to the image processing apparatus 500 for printing.

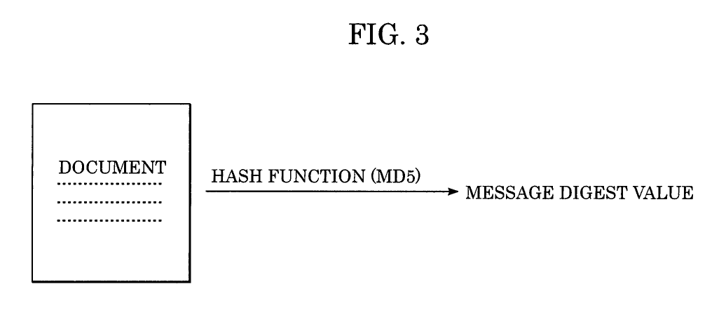

FIG. 3 illustrates data processing performed by the feature value determining unit 205 shown in FIG. 2.

As shown in FIG. 3, in the present embodiment, the feature value determining unit 205 determines a message digest value using a hash function called MD5 (Message Digest 5).

MD5 is used as a message digest function in PGP (Pretty Good Privacy), which is one of the practically used encryption programs. The feature value may be determined using any one-way function other than MD5, such as SHA1 (Secure Hash Algorithm 1).

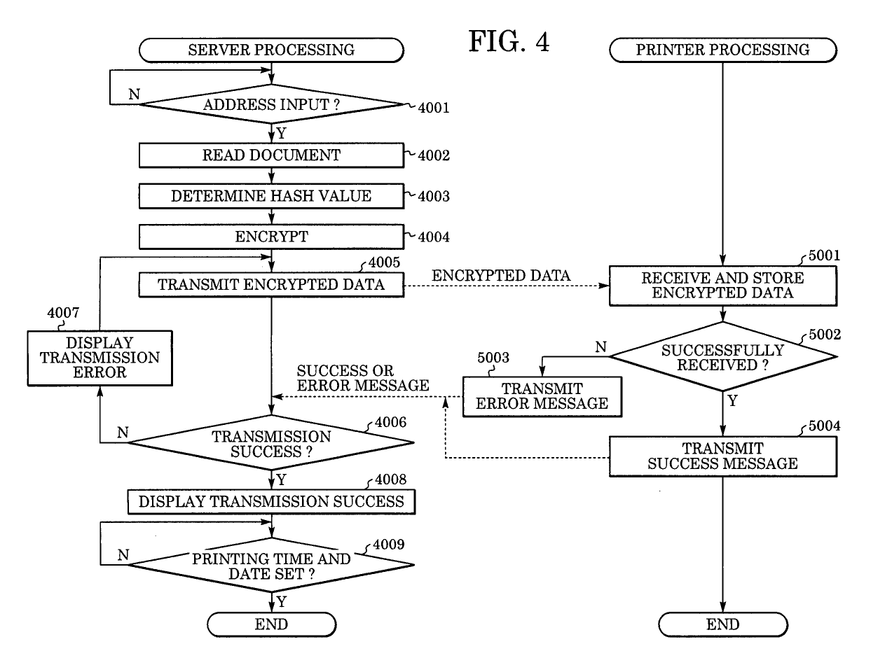

FIG. 4 is a flowchart showing a first data processing procedure performed by the image processing server 200 and image processing apparatus 300, 400 or 500 according to the present invention. In the process shown in FIG. 4, an image processing server 200 transmits electronic data to an image processing apparatus 300, 400 or 500 performing as a printer. The processing of steps 4001 to 4009 is performed by the server, and the processing of steps 5001 to 5004 is performed by the printer. A central processing unit (CPU) (not shown) loads a control program to a random access memory (RAM) from a hard disk or the like and executes the control program, thus performing the processing.

First, the server 200 determines whether or not address information to which data is to be transmitted has been input by the input unit (step 4001). If the address information has been input, a document to be transmitted is read (step 4002). When the document is completely read, the feature value determining unit 205 determines a hash value of the read document data (step 4003), and encrypts the read document data (step 4004). Then, the encrypted document data is transmitted to the address input in step 4001 (step 4005).

The printer receives and stores the document data transmitted from the server (step 5001), and determines whether or not the document data has been successfully received (step 5002). If it is determined that the document data has been successfully received, a normal reception report is sent to the server (step 5004), and then the procedure of the printer 300, 400 or 500 ends.

If it is determined in step 5002 that the document data has not been successfully received, a reception error report is sent to the server (step 5003).

The server determines whether or not the data has been successfully transmitted based on the normal reception or reception error report received from the printer (step 4006). If it is determined that the data has not been successfully transmitted, a transmission error message is displayed on the display unit DP (step 4007). Then, the procedure returns to step 4005, and the encrypted document data is re-transmitted.

If it is determined in step 4006 that the data has been successfully transmitted, a transmission success message is displayed on the display unit DP (step 4008), and the server stands by until a printing time and date at which the transmitted document data is to be printed by the printer is set from the input unit (step 4009). When the printing time and date is set, the procedure of the server 200 ends.

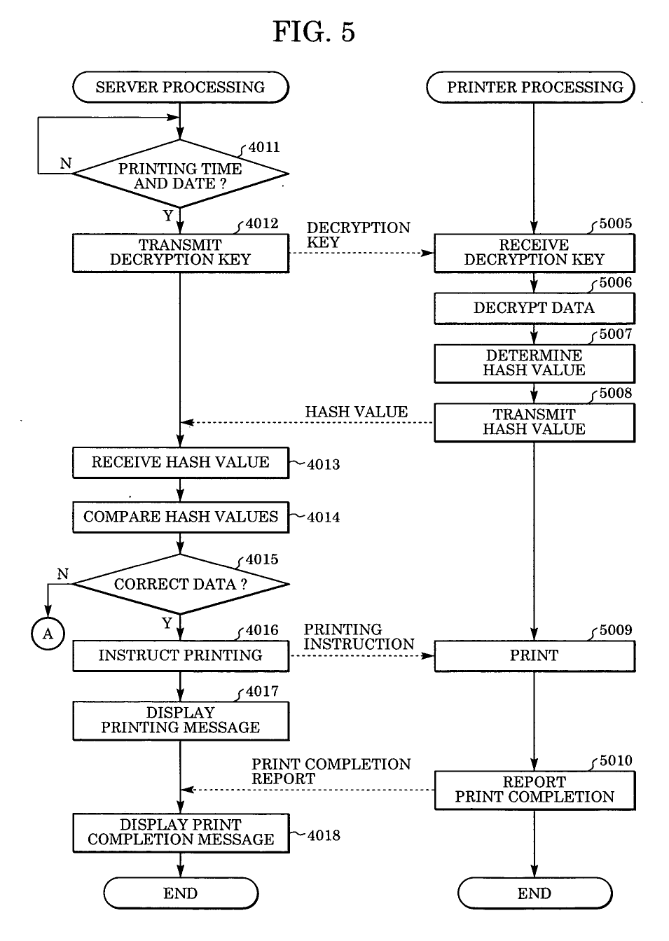

FIG. 5 is a flowchart showing a second data processing procedure performed by the image processing apparatus according to the present invention. In the procedure shown in FIG. 5, encrypted document data is transmitted from the server 200 to the printer 300, 400 or 500, and is then printed. The processing of steps 4011 to 4018 is performed by the server 200, and the processing of steps 5005 to 5010 is performed by the printer 300, 400 or 500.

In step 4011, the server 200 determines whether or not the current time and date is the set printing time and date. If it is determined that the current time and date is the set printing time and date, a decryption key that is generated when the document data is encrypted in step 4004 shown in FIG. 4 is transmitted from the server 200 to the printer 300, 400 or 500 (step 4012).

The printer 300, 400 or 500 receives the decryption key transmitted in step 4012 (step 5005), and decrypts the document data received in step 5001 shown in FIG. 4 (step 5006). The feature value determining unit 302, 402, 502 determines a hash value of the decrypted electronic data (step 5007), and transmits the determined hash value to the server (step 5008).

The server 200 receives the hash value transmitted from the printer 300, 400 or 500 (step 4013), and compares the received hash value with the hash value determined in step 4003 shown in FIG. 4 (step 4014) to determine whether or not the transmitted data has been tampered with, e.g., altered, lost, corrupted (step 4015). If it is determined that the transmitted data is correct, in step 4016, the server 200 instructs the printer 300, 400 or 500 to print the data. Then, the printing status of the data is displayed on the display unit DP of the server 200 (step 4017).

In response to the printing instruction given by the server 200, the printer 300, 400 or 500 prints the document data (step 5009). When all pages are printed, a print completion report is sent to the server (step 5010). Then, the printer 300, 400 or 500 terminates the procedure.

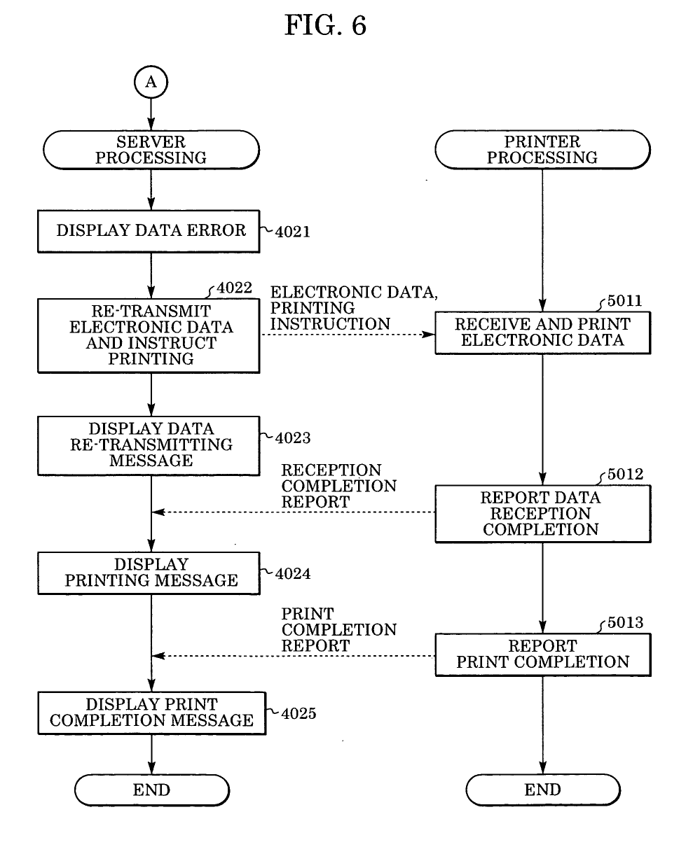

Upon receiving the print completion report from the printer 300, 400 or 500, the server 200 displays a print completion message on the display unit DP (step 4018). Then, the server 200 terminates the procedure. If, however, the server 200 determines in step S4015 that the transmitted data is not correct, processing as shown in FIG. 6 is performed.

FIG. 6 is a flowchart showing a third data processing procedure performed by the image processing apparatus according to the present invention. The procedure shown in FIG. 6 is performed when it is determined in step 4015 shown in FIG. 5 that the transmitted data is not correct. The processing of steps 4021 to 4025 is performed by the server 200, and the processing of steps 5011 to 5013 is performed by the printer 300, 400 or 500.

First, a data error message is displayed on the display unit DP of the server 200 (step 4021). Then, unencrypted electronic data that is stored in advance in the server 200 is re-transmitted to the printer 300, 400 or 500, and a printing instruction is given (step 4022).

A “data being re-transmitted” message is displayed on the display unit DP of the server 200 (step 4023).

While receiving the data re-transmitted from the server 200, the printer 300, 400 or 500 prints the data (step 5011). When the data is completely received, a reception completion report is sent from the printer 300, 400 or 500 to the server 200 (step 5012).

The server 200 receives the reception completion report from a printer 300, 400 or 500, and displays a “printing” message on the display unit DP (step 4024). When printing is completed, the printer 300, 400 or 500 sends a print completion report to the server 200 (step 5013). The server 200 receives the print completion report from the printer 300, 400 or 500, and displays a print completion message on the display unit DP (step 4025). Then, the procedure ends.

In the illustrated embodiment, image data that is captured by an image reading apparatus is encrypted and processed. Any other input data, such as PDL data or electronic document file data (e.g., PDF data), may be encrypted and processed.

In the illustrated embodiment, encrypted data is transmitted to a transmission destination in advance, and the transmission source compares a hash value of the transmitted data with a hash value that is determined by the transmission destination before the data is printed. When the hash values are consistent with each other, the data is printed in response to a printing instruction given by the server. Thus, an image processing environment capable of transmitting data to another device in advance and capable of collectively managing the security of printed data and the printing time and date can flexibly be constructed.

If a printing instruction is not given for a certain period of time or a data corruption command is sent from the server in step 5011 shown in FIG. 6, the decrypted print data may be discarded, and a report indicating that the data has been discarded may be sent to the server.

In the illustrated embodiment, all document image information read by the server is printed by the printer. In a system that is designed so that examination graders do not perform grading in a uniform manner, a portion of the document image information may be masked and processed so that a printable region can be restricted depending upon the transfer destination, or the document image information may be printed with a desired layout in which a plurality of pages are printed into one page or may be printed by a print layout mode instructed by an operating unit of an image processing apparatus, which is a requestee.

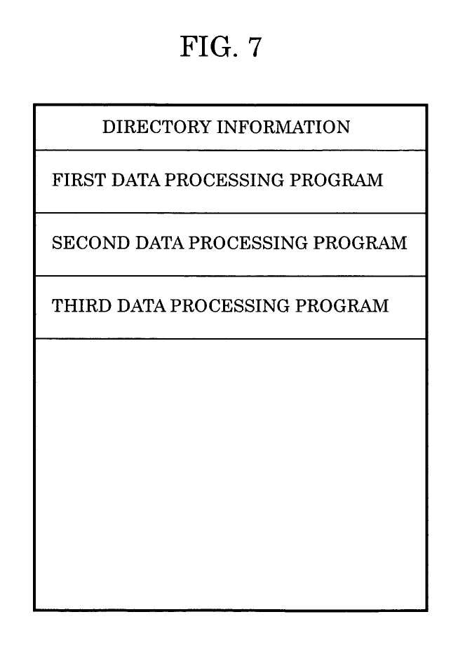

The structure of a data processing program that is readable by an image processing system according to the present invention will now be described with reference to FIG. 7.

FIG. 7 is a memory map of a storage medium, such as a flexible disk (FD) or a compact disk read-only memory (CD-ROM) that stores various data processing programs readable by the image processing system according to the present invention. The storage medium stores directory information, a first data processing program including program code of the processing of the steps shown in FIG. 4, a second data processing program including program code of the processing of the steps shown in FIG. 5, and a third data processing program including program code of the processing of the steps shown in FIG. 6, and so on.

Although not shown, management information for the programs stored in the storage medium, e.g., version information, author information, etc., may be stored, and information that depends upon an operating system (OS) of a program reader, e.g., an icon for identifying a program, may also be stored.

The directory information further includes data dependent upon the programs. A program for installing the programs into a computer, a program for de-compressing a compressed program to be installed, etc., may also be stored.

The functions shown in FIGS. 4 to 6 in the illustrated embodiment may be performed by a host computer according to a program that is installed from an external device. In this case, the present invention is applicable to a case in which an information group including the program is supplied to an output device from a storage medium, such as a CD-ROM, a flash memory, or an FD, or an external storage medium via a network.

The present invention may be implemented by providing a storage medium that stores program code of software implementing a feature of the illustrated embodiment to a system or an apparatus and by causing a computer (or a CPU or an MPU (micro-processing unit)) of the system or apparatus to read and execute the program code stored in the storage medium.

In this case, the program code read from the storage medium implements a new feature of the present invention.

Any program form including the functionality of programs, such as an object code, a program executed by an interpreter, or script data supplied to an OS, may be used.

Storage media for supplying the program may include, for example, a flexible disk, a hard disk, an optical disk, a magneto-optical (MO) disk, a CD-ROM, a CD-R (CD-recordable), a CD-RW (CD-rewritable), a magnetic tape, a non-volatile memory card, a ROM, and a DVD (digital versatile disk).

In this case, the program code read from the storage medium implements a feature of the embodiment.

The program may also be supplied by accessing a homepage on the Internet using a browser of a client computer and downloading a computer program of the present invention or a file having the compressed version of the program and an automatic installation function from the homepage to a recording medium, such as a hard disk. The program code constituting the program of the present invention may be divided into a plurality of files, and these files may be individually downloaded from different homepages. Thus, a WWW (world wide web) server or an FTP (file transfer protocol) server that allows a plurality of users to download a program file implementing a feature of the present invention on a computer may also fall within the scope of the present invention.

A program of the present invention may be encrypted and stored in a storage medium, such as a CD-ROM, and the storage medium may be distributed to users. Only a user who satisfies predetermined conditions may be allowed to download key information for decryption from a homepage via the Internet and to decrypt the encrypted program using the key information, which is then installed into a computer for execution.

A feature of the illustrated embodiment may be implemented not only by executing the program code read by a computer but also by performing a portion of or the entirety of actual processing by an OS or the like running on the computer according to the instruction of the program code.

A feature of the illustrated embodiment may also be implemented by writing the program code read from the storage medium to a memory of a function extension board inserted into the computer or a function extension unit connected to a computer and then performing a portion of or the entirety of actual processing by a CPU or the like of the function extension board or the function extension unit according to the instruction of the program code.

The present invention is not limited to the embodiments and modifications described above, and a variety of changes including an organic combination of the embodiments and modifications may be made according to the present invention.

While the present invention has been described in the context of various examples and embodiments, it is anticipated by those skilled in the art that the spirit and scope of the present invention are not limited to a specific description of this document.

The present invention is not limited to the embodiments described above, and a variety of changes may be made without departing from the scope of the present invention.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-053192 filed Feb. 27, 2004, which is hereby incorporated by reference herein.

1. An image processing apparatus for transmitting encrypted electronic data to an output device, the image processing apparatus comprising:
an extracting unit that extracts first feature information from electronic data that is not encrypted;
an encryption unit that encrypts the electronic data;
a transmitting unit that transmits the encrypted electronic data and a decryption key for decrypting the encrypted electronic data to the output device;
a managing unit that manages the first feature information extracted by the extracting unit and an output time and date at which the encrypted electronic data transmitted by the transmitting unit and stored in the output device is to be output by the output device, so that the transmitting unit transmits the decryption key at the output time and date;
an obtaining unit that obtains second feature information of electronic data that is decrypted by the output device using the decryption key transmitted by the transmitting unit, the second feature information being generated by the output device;
a verifying unit that verifies whether or not the second feature information obtained by the obtaining unit is consistent with the first feature information; and
an instructing unit that instructs the output device to output the decrypted electronic data when the verifying unit verifies that the first feature information is consistent with the second feature information.

2. The image processing apparatus according to claim 1, wherein the managing unit further manages processing state information of the electronic data transmitted to the output device and processed by the output device, and updates output state information of the electronic data in response to an output completion report of the electronic data that is received from the output device.

3. The image processing apparatus according to claim 1, wherein the transmitting unit transmits different decryption keys to a plurality of output devices.

4. The image processing apparatus according to claim 1, further comprising transmission control means for re-transmitting the electronic data that is not encrypted to the output device when the verifying unit determines that the first feature information is not consistent with the second feature information.

5. An image output device for receiving encrypted electronic data from an image processing apparatus and operating a printing process based on the electronic data, the image output device comprising:
a storage unit that stores the encrypted electronic data received from the image processing apparatus;
an obtaining unit that obtains from the image processing apparatus a decryption key for decrypting the encrypted electronic data stored in the storage unit;
a feature information extracting unit that extracts feature information from electronic data decrypted using the decryption key obtained by the obtaining unit, and that transmits the extracted feature information to the image processing apparatus; and
a control unit that controls the printing process of the electronic data according to an output instruction that is received from the image processing apparatus in response to the feature information transmitted to the image processing apparatus by the feature information extracting unit.

6. The image output device according to claim 5, wherein when the image processing apparatus transmits unencrypted electronic data in response to the feature information transmitted by the feature information extracting unit, the control unit causes the unencrypted electronic data to be printed and does not cause the electronic data from which the feature information is extracted to be printed.

7. An image processing method for an image processing apparatus that transmits encrypted electronic data to an output device, the image processing method comprising:
extracting first feature information from electronic data that is not encrypted;
encrypting the electronic data;
transmitting the encrypted electronic data to the output device;
transmitting a decryption key for decrypting the encrypted electronic data to the output device at an output time and date at which the encrypted electronic data that is stored in the output device is to be output by the output device;
obtaining second feature information of electronic data that is decrypted by the output device using the decryption key, the second feature information being generated by the output device;
verifying whether the second feature information is consistent with the first feature information; and
instructing the output device to output the decrypted electronic data when it is determined that the first feature information is consistent with the second feature information.

8. A control method for an image outputting device that receives and outputs encrypted electronic data from an image processing apparatus, the control method comprising:
storing the encrypted electronic data received from the image processing apparatus;
obtaining from the image processing apparatus a decryption key for decrypting the stored encrypted electronic data;
transmitting feature information to the image processing apparatus, the feature information being extracted from electronic data that is decrypted using the decryption key; and
printing the electronic data according to an output instruction that is given by the image processing apparatus in response to the feature information transmitted to the image processing apparatus.

9. A computer program for performing an image processing method for an image processing apparatus that transmits encrypted electronic data to an output device, the computer program comprising:
an extracting module for extracting first feature information from electronic data that is not encrypted;
an encryption module for encrypting the electronic data;
a transmitting module for transmitting the encrypted electronic data and a decryption key for decrypting the encrypted electronic data to the output device;
a managing module for managing the first feature information extracted by the extracting unit and an output time and date at which the encrypted electronic data that is stored in the output device is to be output by the output device, so that the transmitting module transmits the decryption key at the output time and date;
an obtaining module for obtaining second feature information of electronic data that is decrypted by the output device using the decryption key transmitted by the transmitting module, the second feature information being generated by the output device;
a verifying module for verifying whether or not the second feature information obtained by the obtaining module is consistent with the first feature information; and
an instructing module for instructing the output device to output the decrypted electronic data when the verifying module determines that the first feature information is consistent with the second feature information.

10. A computer-readable storage medium storing the computer program according to claim 9.

11. A computer program for performing a control method for an image output device that receives and outputs encrypted electronic data from an image processing apparatus, the computer program comprising:
a storing module for storing the encrypted electronic data received from the image processing apparatus;
an obtaining module for obtaining from the image processing apparatus a decryption key for decrypting the encrypted electronic data stored in the storing module;
a feature information extracting module for extracting feature information from electronic data that is decrypted using the decryption key obtained by the obtaining module and for transmitting the extracted feature information to the image processing apparatus; and
a control module for controlling printing of the electronic data according to an output instruction that is received from the image processing apparatus in response to the feature information transmitted to the image processing apparatus by the feature information extracting module.

12. A computer-readable storage medium storing the computer program according to claim 11.
